(19) United States
(12) Patent Application Publication
(10) Pub. No.: US 2008/0303442 A1
(43) Pub. Date: Dec. 11, 2008

(54) Lamp with Housing Arrangement for the Reduction of Mercury Exposure Towards the Environment in Case of an Explosion of the Burner

(75) Inventors: Holger Moench, Vaals (NL); Jan Alfons Julia Stoffels, Turnhout (BE); Marc Janssen, Kasterlee (BE); Patrick Cyriel Van De Voorde, Turnhout (BE); Peter Claus, Baal (BE); Engelbertus Cornelius Peturs Maria Vossen, Eindhoven (NL); Danny Lambert Elisabeth Van Mechelen, Oost Malle (BE); Andreas Martinus Theodorus Paulus Van Der Putten, Geldrop (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,756

(22) PCT Filed: Jun. 24, 2005
(86) PCT No.: PCT/IB2005/052083

§ 371 Date: Jan. 8, 2007

(30) Foreign Application Priority Data
Jul. 8, 2004 (EP) 04103235.0

(51) Int. Cl. H01J 17/20

(52) U.S. Cl. 313/639

(57) ABSTRACT

The invention relates to a lamp, e.g. a UHP-Lamp, comprising a burner (10) with an ionizable filling and an amount of mercury contained therein, having a housing (30, 60; 20, 30) with at least one port (40), whereby the inner opening surface (50) area of the port/s is adapted to reduce the amount of mercury which is able to expose to the outside after an explosion of the burner (10).

The present invention relates to a lamp containing mercury, e.g. an UHP (Ultrahigh-performance) lamp.

In present art UHP lamps, it is necessary to use mercury to achieve proper operation of the lamp. Although the amounts used are merely in the range of 10-25 mg per lamp, there has been a growing concern that in case of an explosion of the lamp, the environment of the lamp might be exposed to and contaminated by the mercury. Such explosions can up to date never be avoided, even with the highest standard lamps. The main two reasons for such lamp explosions are:
1.) The explosion takes place when the lifetime of the lamp has nearly ended due to blow-up because of crystallisation of the quartz bulb. By monitoring the lamp voltage, these blow-ups can be avoided, if the lamp is switched off, when certain criteria are met. A control device is e.g. disclosed in the EP 1 076 478.
2.) The explosion takes place due to stresses in the quartz. This can up to date not be detected and may lead to explosion during any time the bulb is operated.

Since the risk of an explosion of the lamp cannot be eliminated, it must be taken care that the mercury contained inside the lamp is not released to the environment, if such an explosion happens.

It is therefore an object of the present invention to provide a device which is capable of effectively reducing a significant amount, if not all of the mercury contained in the lamp to advance to the environment of the lamp in case an explosion happens.

These objects are achieved by a lamp as disclosed in claim 1 of the application. Accordingly, Lamp comprising a burner with an ionizable filling and an amount of mercury contained therein is provided, whereby the burner is surrounded by a housing and whereby the housing comprises at least one port with an opening, whereby the inner opening surface area/s thereof is ≧0 mm² and ≦20 mm².

Preferably the inner opening surface area/s is ≧1 mm² and ≦15 mm², more preferred ≧3 mm² and ≦10 mm².

Accordingly, the preferred diameter for the opening/s—in case that round opening/s are used—is ≧0 mm and ≦10 mm, more preferably ≧1 mm and ≦7 mm and most preferred ≧2 mm and ≦4 mm. In case that more than one opening is present, the diameter of the openings are selected independent from each other.

The inventors have studied the problem of reducing the amount of mercury that is exposed to the environment after an explosion of the burner and found the following:

After an explosion of the burner occurred, a significant amount of gas and/or fluid will—together with the components that were in the burner before the explosion—be released. Therefore it is disadvantageous to provide the burner in a housing that has no port, since that will lead to overpressure stress. Especially the front glass is susceptible to overpressure stress e.g. that it will break or the sealing of the front glass will be destroyed.

On the other hand, the inner openings of the ports must not be too large, because then the flow of fluid and/or gas will become too large, thus allowing a too large amount of mercury to advance to the outside of the housing. Furthermore it is advantageous to have smaller inner openings, because then some particles, which were in the burner before the explosion, cannot leave the housing of the lamp, since they are too big to fit through the port/s. If the burner is operated in a housing without a port and the housing is airtight there will be a pressure increase in the housing. This will make the design more complex. When there is a port there will be no pressure difference during operation of the lamp. Indeed after a burner explosion there will be in some applications be a pressure increase but the pressure increase will be limited

On the other hand it is disadvantageous if the flow is too slow, because then there exists the danger of causing overpressure stress, too. Therefore it is required for the inner openings of the housing to have a certain minimum size. The diameter of the hole, via the flow resistance, determines the speed with which the air will escape after a burner explosion.

It is furthermore believed that the amount of mercury that is allowed to leave the housing of the lamp after an explosion occurred in particular on the following six factors may be decisive:

1. The Initial Amount of Hg Put in the Burner

Preferably the initial amount of Hg ranges from ≧5 to ≦30 mg Hg, more preferred from ≧10 to ≦25 mg Hg.

2. The Hg Pressure in the Burner During Normal Lamp Operation

Preferably the Hg pressure ranges from ≧100 to ≦400 bar, more preferably from ≧200 to ≦350 bar.

3. The Inner Volume of the Burner

The preferred inner volume of the burner depends on the outer diameter of the burner. For a burner with approx. 9 mm outer diameter the preferred inner volume is 240 mm³ to ≦70 mm³, preferably ≧50 mm³ to ≦60 mm³; for a burner with approx. 10 mm outer diameter the preferred inner volume is ≧45 mm³ to ≦75 mm³, preferably ≧55 nm u to ≦70 mm³ and most preferred ≧60 mm³ to ≦65 mm³;

4. The Volume of the Housing

It is preferred that the housing is as big as possible. On the other hand housing sizes are determined by the available size in the applications and thus there is a drive to make them as small as possible

5. The Flow Resistance of the Defined Leakage Way

This determines the speed with which the air in the housing will escape. This flow resistance is determined by among others diameter, length, shape of the port in the housing

6. How Fast the Air in the Housing Will Cool Down after an Explosion

After a burner explosion there will be a pressure increase in the housing. The pressure will reduce to ambient pressure by air escaping to the outside of the housing. As already mentioned the speed is determined by the flow resistance. On the other hand after an explosion also the temperature of the air in the housing will cool down causing a drop of pressure in the housing. It is expected that cooling time for the air in the house is too slow to effect the amount of air that will escape from the housing.

When after an explosion there is a pressure equilibrium: during cooling down of the air in the housing, fresh air will be sucked into the housing.

It should be noted that the factors 1 to 4 and 6 often depend on the application, for which the lamp is intended to be used.

By choosing the inner opening surface area of ≧0 mm² and ≦20 mm², thus giving regard to factor 5, it is possible to effectively reduce the amount of mercury to advance to the outside of the housing and/or the lamp without causing overpressure stress.

According to a preferred embodiment of the present invention, a Lamp is provided, whereby
the housing has an inner volume V₁ and
the burner (10) has an inner volume V₂ and an inner pressure p₂ and whereby the total inner opening surface area A of the port/s of the housing is provided in that way that

I calculated this figures (and the other figures in the application) from the data you gave me.
the ratio of the total inner opening surface area A (in mm²) to V₁ (in mm³) is ≧1:20000 and ≦1:1000000 and/or
the ratio of the total inner opening surface area A (in mm²) to V₂×p₂ (in mm³ bar) is ≧1:400 and ≦1:30000.

By doing so, it is in particular possible to give regard to the factors 1 to 3 in relation to 4 to 6. In case, a bigger burner is used, it is advantageous to match the total inner opening surface area A to the burner dimensions and pressure. Alternatively or additionally it is advantageous to match the total inner opening surface area A to the dimensions of the housing.

Therefore it is advantageous that the total inner opening surface area A, which is in the present invention defined as being the sum of all inner opening surface areas of the opening/s in the housing is matched either to the inner volume of the housing or to the product of the inner volume of the burner and the inner pressure of the burner or both. Since there may be several openings and/or ports, it is advantageous that the total inner opening surface areas A is kept within certain borders in order to keep the flow of fluid out of the housing in an desired level and avoiding overpressure stress.

If the inner opening surface area A is matched to the inner volume of the housing, the ratio of the total inner opening surface area A (in mm²) to V₁ (in mm³) is ≧1:20000 and ≦1:1000000, preferably ≧1:50000 and ≦1:500000, more preferably ≧1:75000 and ≦1:400000 and most preferred ≧1:100000 and ≦1:300000.

If the inner opening surface area A is matched to the product of the inner volume of the burner and the inner pressure of the burner, the ratio of the total inner opening surface area A (in mm²) to V₂×p₂ (in mm³ bar) is ≧1:400 and ≦1:30000, preferably ≧1:750 and ≦1:20000, more preferably ≧1:1000 and ≦1:10000 and most preferred ≧1:1500 and ≦1:5000.

By doing so, the amount of mercury that is exposed to the environment of the housing is significantly reduced while the dangers of overpressure stress are minimized. Preferably the total inner opening surface area A, is matched both to the inner volume of the housing or to the product of the inner volume of the burner and the inner pressure of the burner.

It should be noted that preferably the lamp according to the present invention is not cooled by a flow of a fluid (e.g. air or gas) towards the lamp. However, cooling devices (such as e.g. a fan) may be present.

According to a preferred embodiment of the present invention, the inner opening surface area/s of the opening/s (40) and/or the total inner opening surface area A are provided in that way that the flow of fluid through the at least one opening out of the housing after an explosion occurred is ≧0 mm³ per s and ≦ 1/10 V₁ per s. If has been shown that keeping the flow of fluid through the at least one opening out of the housing after an explosion occurred within these borders is most suitable for both achieving a good reduction of the amount of mercury which is advancing outside the housing whilst giving regard to the dangers of overpressure stress. Preferably the flow of fluid through the at least one opening out of the housing after an explosion occurred is ≧1 cm³ per s and ≦10 cm³ per s, more preferably ≧2 cm³ per s and ≦8 cm³ per s and most preferred ≧3 cm³ per s and ≦5 cm³ per s.

According to a preferred embodiment of the present invention, the increase in pressure, measured immediately outside the housing is ≧0 mbar and ≦100 mbar for the time period of ≧0 seconds and ≦100 seconds after an explosion of the burner occurred.

According to a preferred embodiment of the present invention, the housing has a cylindrical shape, preferably with a height of ≧70 mm and ≦140 mm, more preferably ≧90 mm and ≦120 mm, and most preferred ≧1200 mm and ≦110 mm and/or a diameter of ≧70 mm and ≦140 mm, more preferably ≧90 mm and ≦120 mm, and most preferred ≧100 mm and ≦110 mm. This has been shown in practice to be the optimal dimensions for a housing.

However, also other shapes for the housing are preferred within the present invention. According to a preferred embodiment of the present invention, the housing has a square or rectangular shape, preferably with a height of ≧70 mm and ≦140 mm, more preferably ≧90 mm and ≦120 mm, and most preferred ≧100 mm and ≦110 mm and/or a width and/or length of ≧70 mm and ≦140 mm, more preferably ≧90 mm and ≦120 mm, and most preferred ≧100 mm and ≦110 mm. This has been shown in practice to be the optimal dimensions for a housing.

According to a preferred embodiment of the present invention, the lamp comprises at least one chamber being arranged adjacent to the housing,
whereby the at least one chamber comprises a first port which is fluidically connected with the housing via at least one port of the housing, so that fluid can pass from the housing to and inside the chamber
whereby the at least one chamber comprises at least a second port with at least one second opening through which fluid can pass towards the outside of the chamber

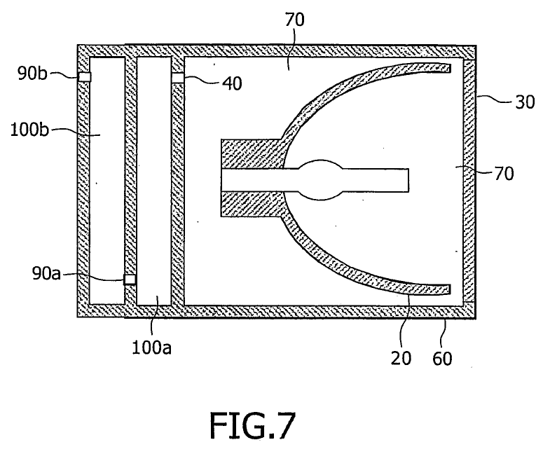

By doing so, fluid that is advancing out of the housing after an explosion of the burner will first pass the at least one chamber before reaching the environment. It should be noted that the term “fluidically connected with the housing” also means, that a chamber may be fluidicially connected with the housing via a further chamber (as e.g. shown in FIG. 7 which is to be discussed below). It goes without saying that fluid, that passes towards the outside of a chamber as described above may then enter another chamber as described above (which can also e.g. be seen in FIG. 7 which is to be discussed below).

When using one (or more) chambers according to the present invention, it is advantageous that the ports of the chambers are set up in a way that the fluid will after entering the chamber—pass ≧50% and ≦100% of the inner volume of the chamber before leaving the chamber. Preferably the fluid will pass ≧70%, more preferably ≧80%, most preferred ≧90%, and ≦100% of the inner volume of the chamber before leaving the chamber. This is advantageous, since then the fluid has time to cool down, thereby reducing the pressure and the flow. Preferably, the first and second port/s of the chamber are spaced from each other and/or shifted against each other, preferably in that way that the first and second port/s of the chamber are not on the same height.

According to a preferred embodiment of the present invention, the chamber/s have a cylindrical shape, preferably with a diameter of ≧40 mm and 990 mm, more preferably ≧50 mm and ≦80 mm, and most preferred ≧60 mm and ≦70 mm and/or a height of ≧10 mm and ≦25 mm, more preferably ≧12 mm and ≦20 mm, and most preferred ≧15 mm and ≦18 mm, whereby in case that several chambers are present, the dimensions and shapes of the chambers are selected independent from each other. By choosing such dimensions for the chamber/s, the volume increase due to the burner rupture can best be coped with in order to minimize the amount of mercury to advance to the outside of the lamp.

However, also other shapes for the chamber/s are preferred within the present invention. According to a preferred embodiment of the present invention, the chamber/s have a square or rectangular shape, preferably with a length and/or width of ≧40 mm and ≦90 mm, more preferably ≧50 mm and ≦80 mm, and most preferred ≧60 mm and ≦70 mm and/or a height of ≧10 mm and ≦25 mm, more preferably ≧12 mm and ≦20 mm, and most preferred ≧15 mm and ≦18 mm, This has been shown in practice to be the optimal dimensions for a housing.

According to a preferred embodiment of the present invention, the at least one second opening has an inner opening surface area, the inner opening surface area/s being provided in that way that the ratio of the inner opening surface area/s of the second opening/s of the at least one chamber to the inner opening surface area/s of the opening/s of the at least one port of the housing is ≧1:1000 and ≦1:70000. By doing so, the pressure drop from the housing to the chamber/s to the environment can be adjusted in a desired way.

Preferably, the ratio of the inner opening surface area/s of the second opening/s of the at least one chamber to the inner opening surface area/s of the opening/s of the at least one port of the housing is ≧1:2000 and ≦1:50000, more preferably ≧1:3500 and ≦1:20000 and most preferred ≧1:5000 and ≦1:10000.

According to a preferred embodiment of the present invention, the at least one chambers has an inner volume, whereby the ratio of the inner volume/s of the at least one chamber to the inner volume of the housing is ≧1:7,5 and ≦1:35. This is preferably done in applications, where several chambers are “in a row”, i.e. in that way that fluid flows from the housing in a first chamber, then in a second chamber, then possibly in further optional chambers and then to the outside. It has been found out that by adjusting the inner volumes of the chamber/s in ratio to the inner volume as described, the flow of fluid can be regulated in a desired way. Preferably, the ratio of the inner volume/s of the at least one chamber to the inner volume of the housing is ≧1:10 and ≦1:30, more preferably ≧1:12,5 and ≦1:25 and most preferred ≧1:15 and ≦1:20.

According to a preferred embodiment of the present invention, each of the at least one chambers has an inner volume, whereby the total inner volume V₃, being the sum of each inner volume of each of the at least one chamber/s, to the inner volume V₁ of the housing is ≧1:1 and ≦1:35. This is preferably done in applications, where several chambers are “in parallel”, i.e. in that way that fluid flows from the housing via a first port in a first chamber and via further ports in several other chambers. It has been found out that by adjusting the inner volumes of the chamber/s in ratio to the inner volume as described, it is secured that the flow of fluid will be within the wanted flow ratio. Preferably, the ratio of V₃ to the inner volume of the housing is ≧1:2 and ≦1:30, more preferably ≧1:4 and ≦1:20 and most preferred ≧1:5 and ≦1:10.

According to a preferred embodiment of the present invention, at least one of the chambers has a common wall section with the housing. By doing so, a compact design of the lamp is possible and the number of parts needed is reduced. Preferably, this at least common wall section with the housing comprises a port opening.

According to a preferred embodiment of the present invention, at least one of the chambers is provided with a mercury absorbing/adsorbing and/or blocking means. By doing so, it is possible to hinder some—if not all of the mercury to advance from the chamber/s to the environment.

A lamp according to the present invention is preferably incorporated in a system which is designed for the usage in one or more of the following applications:

shop lighting,

home lighting,

head lamps

accent lighting,

spot lighting,

theater lighting,

Office lighting

Illumination of workplaces

Automotive front lighting

Automotive auxiliary lighting

Automotive interior lighting

consumer TV applications,

fiber-optics applications, and

projection systems

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

Additional details, characteristics and advantages of the object of the invention are disclosed in the subclaims and the following description of the respective figures—which in an exemplary fashion—show several preferred embodiments of a lamp according to the invention.

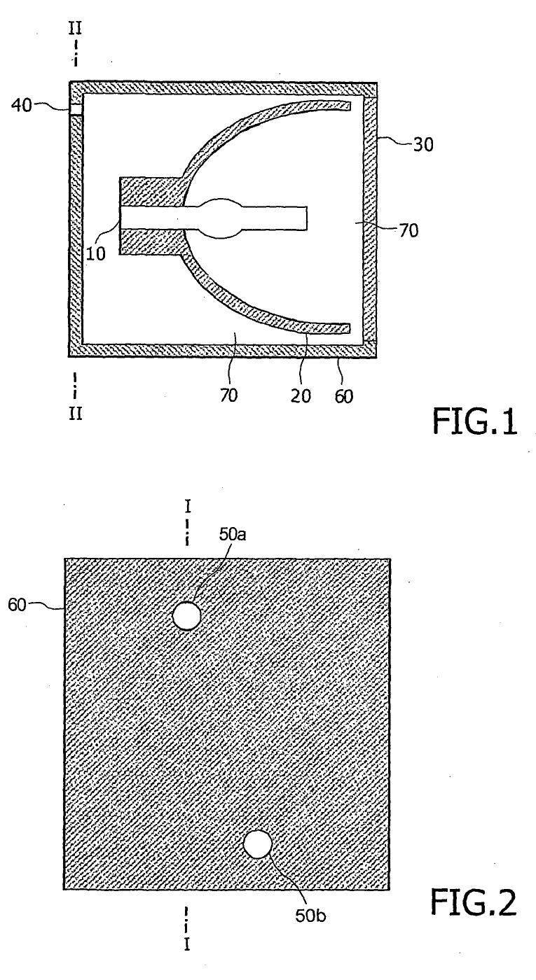

FIG. 1 shows a cross-sectional schematic view of a first embodiment of a lamp according to the present invention along line I-I in FIG. 2

FIG. 2 shows a cross-sectional schematic view of a wall section of the housing of the lamp along line II-II in FIG. 1

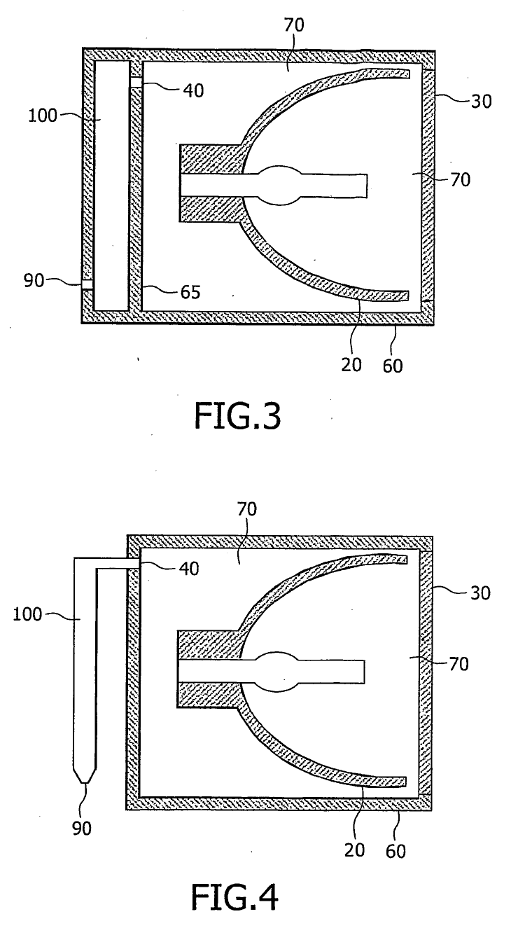

FIG. 3 shows a cross-sectional schematic view of a second embodiment of a lamp according to the present invention with an additional chamber

FIG. 4 shows a cross-sectional schematic view of a third embodiment of a lamp according to the present invention with an additional chamber:

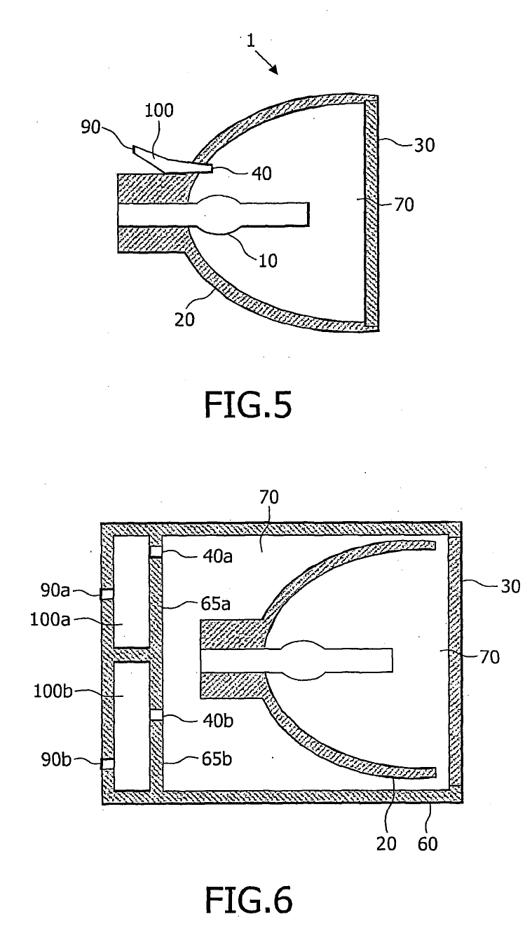

FIG. 5 shows a cross-sectional schematic view of a fourth embodiment of a lamp according to the present invention with an additional chamber

FIG. 6 shows a cross-sectional schematic view of a fifth embodiment of a lamp according to the present invention with two additional chambers

FIG. 7 shows a cross-sectional schematic view of a sixth embodiment of a lamp according to the present invention with two additional chambers

FIG. 1 shows a cross-sectional schematic view of a first embodiment of a lamp according to the present invention along line I-I in FIG. 2, FIG. 2 shows a cross-sectional schematic view of a wall section of the housing of the lamp along line II-II in FIG. 1. The lamp comprises a burner 10, a reflector 20, a front glass 30 and a sheath 60. In this embodiment, the front glass 30 and the sheath 60 form the housing, which has an inner volume 70 V₁. The burner 10 has an inner volume V₂ and an inner pressure p₂. The burner as such is known in the art and not part of the invention; however, all known types and components may be used within the present invention.

As can be seen from FIGS. 1 and 2, the housing, which is formed by the sheath 60 and the front glass 30 comprises two ports 40 (although only one can be seen in FIG. 1 due to the cross-section). These two ports have each an inner opening surface 50a, 50b, each of them having an area which is ≧0 mm² and ≦20 mm², preferably ≧1 mm² and ≦15 mm², more preferred ≧3 mm² and ≦10 mm².

The total inner opening surface A is the sum of the areas of all inner opening surface/s, in this embodiment the sum of both inner opening surfaces 50a and 50b. The inner opening surface A has been set to match that the ratio of the total inner opening surface area A (in mm²) to V₁ (in mm³) is ≧1:20000 and 1:1000000, preferably ≧1:50000 and ≦1:500000, more preferably ≧1:75000 and ≦1:400000 and most preferred ≧1:100000 and ≦1:300000.

It should be noted that the shown diameters of the ports 40 and the inner openings 50a, b are schematic and have been enlarged in order for readability purposes. In most applications, the dimensions of these components are different.

Furthermore it should be noted that in this embodiment the port 40 has been formed as a cylindrical through-hole. This does not always need to be the case; also cube-like or conical ports may be used within the present invention and may be advantageous for certain applications.

FIG. 3 shows a cross-sectional schematic view of a second embodiment of a lamp according to the present invention with an additional chamber. This chamber 100 comprises a first port which is fluidically connected with the housing via at least one port of the housing, so that fluid can pass from the housing to and inside the chamber 100. In this embodiment, this port is identical with the port 40. Furthermore the chamber 100 comprises a second port 90 with at least one second opening (not shown in the figs) through which fluid can pass towards the outside of the chamber. The ratio of the inner opening surface area of the second opening of the chamber 100 to the inner opening surface area of the opening of the port 40 of the housing is ≧5:1 and ≦1:5.

The ports of the chamber are set up in that way that the fluid will—after entering via the port 40—pass approx. 90% of the inner volume of the chamber 100 before leaving via the port 90. This is advantageous, since then the fluid has time to cool down, thereby reducing the pressure and the flow.

Furthermore, the volume of the chamber has been set so that the ratio of the inner volume of the chamber 100 to the inner volume of the housing is ≧1:7,5 and ≦1:35. This way, the flow rate of the fluid as it advances towards the environment is furthermore controlled in a desired way.

The chamber 100 is in this embodiment provided in that way that it has a common wall section 65 with the housing 60. This is insofar preferred as it gives the possibility to build up a more compact device, which is easy to produce and is more stable as when the chamber 100 is a “separate” component.

However, the chamber 100 may be also “separate”. This is shown in FIG. 4. FIG. 4 shows a cross-sectional schematic view of a third embodiment of a lamp according to the present invention with an additional chamber. This chamber 100 also comprises a first port which is fluidically connected with the housing via at least one port of the housing, so that fluid can pass from the housing to and inside the chamber 100. In this embodiment, this port is identical with the port 40. Furthermore the chamber 100 comprises a second port 90 with at least one second opening (not shown in the figs) through which fluid can pass towards the outside of the chamber. The ratio of the inner opening surface area of the second opening of the chamber 100 to the inner opening surface area of the opening of the port 40 of the housing is ≧5:1 and ≦1:5.

In the embodiment as shown in FIG. 4, the chamber 100 is formed as a cylindrical pipe with two ports 40,90. In this regard it is preferred that the inner diameter of the chamber 100 is greater than the diameter of the inner opening of each the ports 40, 90.

In this embodiment, the inner volume of the chamber 100 has also been set so that the ratio of the inner volume of the chamber 100 to the inner volume of the housing is ≧1:7,5 and ≦1:35. This way, the flow rate of the fluid as it advances towards the environment is furthermore controlled in a desired way.

FIG. 5 shows a cross-sectional schematic view of a fourth embodiment of a lamp according to the present invention with an additional chamber. In this embodiment, the sheath has been omitted. Therefore the housing according to this embodiment is formed out of the reflector 20 and the front glass 30, which are connected to each other. The inner volume 70 of the housing is then in most applications smaller than in those embodiments, where a separate sheath is present. Also in this embodiment, a chamber 100 as described above with two ports 40, 90 is present. The chamber 100 is in this embodiment formed as a “bended pipe”. It should be noticed that one is free to chose any form for the chamber 100. So the chamber 100 may be set in order to meet further requirements for the chosen application.

FIG. 6 shows a cross-sectional schematic view of a fifth embodiment of a lamp according to the present invention with two additional chambers. The two chambers 100a, 100b each have two ports 40a, 90a and 40b, 90b, respectively, as described above. They also each have a common wall section 65a and 65b, respectively with the housing.

The total inner volume V₃, being the sum of the two inner volume of the two chambers 100a 100b to the inner volume V₁ of the housing is ≧1:1 and ≦1:35. It has been found out that by adjusting the inner volumes of the chamber/s in ratio to the inner volume as described, it is secured that the flow of fluid will be within the wanted flow ratio. Preferably, the ratio of V₃ to the inner volume of the housing is ≧1:2 and ≦1:30, more preferably ≧1:4 and ≦1:20 and most preferred ≧1:5 and ≦1:10.

It should be noted that the two different chambers 100a, 100b do not need to have an identical size. For some applications (e.g. when there is a draught from devices located in the environment) it may be advantageous to have different sizes for the chambers, since then the time, which the fluid will take to pass through each of the chambers is different and can thus be adapted.

FIG. 7 shows a cross-sectional schematic view of a sixth embodiment of a lamp according to the present invention with two additional chambers. These chambers 100a, 100b are “in a row”, so that chamber 100b is fluidically connected with the port 40 of the housing via chamber 100a. As can be seen from FIG. 7, the ratios of the inner volumes of the two chambers to the inner volume of the housing is ≧1:7,5 and ≦1:35. This ensures that the fluid will on the one hand move steadily from the housing and the burner 10; on the other hand, the fluid will stay in each of the chambers 100a, 100b for a time long enough to cool down, thereby reducing pressure and the flow.

1. Lamp comprising a burner (10) with an ionizable filling and an amount of mercury contained therein, whereby the burner (10) is surrounded by a housing (60, 30; 20, 30), whereby the housing (60, 30; 20, 30) comprises at least one port (40) with an opening (50), whereby the inner opening surface area/s thereof is ≧0 mm² and ≦20 mm².

2. A Lamp according to claim 1, whereby the inner opening surface area/s thereof is ≧1 mm² and ≦15 mm², more preferred ≧3 mm² and ≦10 mm.

3. A Lamp according to claim 1
whereby the housing (60, 30; 20, 30) has an inner volume V₁ (70) and
whereby the burner (10) has an inner volume V₂ and an inner pressure p₂
whereby the total inner opening surface area A of the port/s of the housing (60, 30; 20, 30) is provided in that way that
the ratio of the total inner opening surface area A (in mm²) to V₁ (in mm³) is ≦1:20000 and ≦1:100000 and/or
the ratio of the total inner opening surface area A (in mm²) to V₂×p₂ (in mm³ bar) is ≦1:400 and ≦1:30000.

4. The lamp according to claim 1, whereby the inner opening surface area/s of the opening/s (40) and/or the total inner opening surface area A are provided in that way that the flow of fluid through the at least one opening out of the housing (60, 30; 20; 30) after an explosion occurred is ≧0 mm³ per and ≧ 1/10 V1 per s.

5. The lamp according to claim 1, wherein the lamp comprises at least one chamber being arranged adjacent to the housing,
whereby the at least one chamber (100, 100a, 100b) comprises a first port (40,40a, 90a) which is fluidically connected with the housing (60, 30; 20, 30) via at least one port (40,40a, 40b) of the housing, so that fluid can pass from the housing to and inside the chamber (100, 100a, 100b)
whereby the at least one chamber (100, 100a, 100b) comprises at least a second port (90, 90a, 90b) with at least one second opening through which fluid can pass towards the outside of the chamber

6. The lamp according to claim 1, wherein each of the at least one second opening has an inner opening surface area, the inner opening surface area/s being provided in that way that the ratio of the inner opening surface area/s of the second opening/s of the at least one chamber to the inner opening surface area/s of the opening/s of the at least one port of the housing is ≧5:1 and ≦1:5.

7. The lamp according to claim 5, whereby each of the at least one chamber/s 100, 100a, 100b) has an inner volume, whereby the ratio of the inner volume/s of the at least one chamber to the inner volume V₁ (70) of the housing (30, 60; 20, 30) is ≧1:7,5 and ≦1:35.

8. The lamp according to claim 5, whereby each of the at least one chamber/s (100, 100a, 100b) has an inner volume, whereby the total inner volume V₃, being the sum of each inner volume of each of the at least one chamber/s (100, 100a, 100b), to the inner volume V₁ (70) of the housing (30, 60; 20, 30) is ≧1:1 and ≦1:35.

9. The lamp according to claim 5, whereby at least one of the chambers (100, 100a, 100b) has a common wall section (65, 65a, 65b) with the housing (30, 60; 20, 30).

10. A system incorporating a lamp according to claim 1 and being used in one or more of the following applications:
shop lighting,
home lighting,
head lamps
accent lighting,
spot lighting,
theater lighting,
Office lighting
Illumination of workplaces
Automotive front lighting
Automotive auxiliary lighting
Automotive interior lighting
consumer TV applications,
fiber-optics applications, and
projection systems.
